(19) United States
(12) Patent Application Publication
(10) Pub. No.: US 2016/0255819 A1
(43) Pub. Date: Sep. 8, 2016

(54) BIRD FEEDER WITH SPRING-BIASED PERCH WITH MAGNET ASSIST

(71) Applicant: Aspects, Inc., Warren, RI (US)

(72) Inventor: Jesse Faunce, Raynham, MA (US)

(73) Assignee: Aspects, Inc., Warren, RI (US)

(21) Appl. No.: 15/058,291

(22) Filed: Mar. 2, 2016

Related U.S. Application Data
(60) Provisional application No. 62/127,521, filed on Mar. 3, 2015.

(51) Int. Cl. A01K 39/01

(52) U.S. Cl. CPC A01K 39/0113

(57) ABSTRACT

The bird feeder body includes a base with a number of perches connected thereto by a coil spring, which is tensioned and configured so that when an animal of a predetermined weight is positioned thereon, the perch will collapse to move the animal to a position that is enough below the feed aperture of the feeder body to make unwanted feeding much more difficult if not impossible for the unwanted animal. In addition, a magnet is positioned underneath the feeder base above the desired location the perch for normal feeding by a desired bird. The magnet assists in locating the perch in the correct position and helps retain it in place. Also, the magnet attraction between the magnet and the perch can be modified to help control how much weight is needed on the perch before it collapses and breaks away.

### CROSS-REFERENCE TO RELATED APPLICATION

This patent document claims priority to earlier filed U.S. Provisional Application Ser. No. 62/127,521, filed on Mar. 3, 2015, the entire contents of which are incorporated herein by reference.

### BACKGROUND OF THE INVENTION

1. Field of the Invention

The present patent document relates generally to bird feeders and more specifically to a breakaway perch configured to block heavier birds and squirrels from access to the seed in bird feeders.

2. Background of the Related Art

Selective bird feeders are well known in the art and are designed to limit the maximum size of a bird or animal, which can access the seed in the feeder. The reasons for excluding certain birds may be many. For instance, larger birds such as cardinals, crows, grackles, blue jays and the like are considered by some people to be undesirable.

A further problem associated with bird feeders is preventing rodents from gaining access to the seed. In particular, squirrels are well known for their ability to reach and devour the seed in a bird feeder. Many approaches have been tried to discourage or prevent squirrels from reaching the bird feeder, including various types of domes, covers and baffles on poles. These may not be successful, as the squirrels have shown great ingenuity in overcoming such devices.

Some of the attempted solutions to the problem are disclosed in the prior art such as exemplified by U.S. Pat. No. 6,415,737, issued to Banyas, teaches a collapsible perch for a bird feeder retained by spring tension. However, positioning of the perch relies solely on a spring member, which may weaken over time resulting in poor performance of the perch. U.S. Pat. No. 6,578,518, issued to Conforti, also describes a bird feeder that includes a perch that tips or collapses, which uses a rotationally wound spring to spring-bias the perch into an open position. Both of the above perches are supported by springs whereby heavier birds or mammals on the perch cause the perch to move downwardly to make it more difficult to gain access to the feed in the feeder via a feed port.

There have been further attempts to provide a breakaway perch that uses magnets instead of spring to bias the perch into a feeding position. For example, U.S. Pat. No. 7,694,652, issued to Fahey, provides a perch that has an end that is magnetically attracted to a portion of the housing of the feeder. When sufficient weight is on the perch to overcome the magnetic attraction, the perch breaks away. Similarly, U.S. Pat. No. 8,807,081, issued to Gage et al., provides a perch that is pivotally connected to the feeder housing via a lever construction so that the perch on one side of the lever pivots between a feed position and a deterrent position. A magnet on the opposing side releasably engages with a complimentary magnetic surface on the feeder housing to relocate the perch portion of the lever when there are no unwanted animals on the perch.

While the above references disclose collapsible perches, such devices suffer from the reliance on either a spring member or magnetic attraction to help position the perch in a feed position for a bird after an unwanted animal is no longer on the perch. This results in unreliable and erratic performance of the perch, which may cause the feeder not be used by desired birds because they are not able to reliably access the feed while on the perch. Also, such prior art feeders and perches are complicated and/or expensive to produce, or insufficiently robust to survive repeated assaults by rodents. Accordingly, there is a perceived need in the marketplace for a collapsible perch that is inexpensive, yet, sensitive and resilient enough to deter rodents and undesirable birds.

### SUMMARY OF THE INVENTION

The present invention solves the problems of the prior art by providing a spring-tensioned perch configured to collapse when set upon by undesirable animals, such as squirrels or heavier birds, such as a blue jays, yet have sufficient strength to support the weight of lighter, desirable song birds. The perch of the present invention uses both prior art springs and magnets for superior operation and reliability.

The present invention provides for a bird feeder body with a base with a number of perches connected thereto by a spring such as a coil spring. The coil spring is tensioned and configured so that when an animal of a predetermined weight is positioned thereon, the perch will collapse to move the animal to a position that is enough below the feed aperture of the feeder body to make unwanted feeding much more difficult if not impossible for the unwanted animal. In addition, a magnet is positioned underneath the feeder base above the desired location the perch for normal feeding by a desired bird. The magnet assists in locating the perch in the correct position and helps retain it in place. Also, the magnet attraction between the magnet and the perch can be modified to help control how much weight is needed on the perch before it collapses and breaks away.

Therefore, there is a need for a collapsible perch to reliably break away when an animal of given weight is positioned on the perch.

There is also a need for a feeder with a collapsible perch that is inexpensive and easy to use.

There is a further need for a feeder with a collapsible perch that employs both a spring member for biasing the perch to a feed position and a magnet for assist of positioning the perch in place.

### BRIEF DESCRIPTION OF THE DRAWINGS

These and other features, aspects, and advantages of the present invention will become better understood with reference to the following description, appended claims, and accompanying drawings where:

FIG. 1 is a perspective view of a bird feeder equipped with the collapsible perch of the present invention;

FIG. 2 is a bottom perspective view of the construction of the perch of the present invention in a resting state suitable for use by desired birds for normal feeding;

FIG. 3 is a bottom view of the perch of the present invention in a resting state suitable for use by desired birds for normal feeding;

FIG. 4 is a side view of a feeder equipped with the present invention with the rightmost perch being actuating downwardly simulating the weight of an undesirable animal positioned thereof;

FIG. 5 is a bottom perspective view of the feeder of FIG. 4 with the right perch perch being actuating downwardly simulating the weight of an undesirable animal positioned thereof;

FIG. 6 is a top perspective view of use of the collapsible perch of the present invention in a hopper-type bird feeder;

FIG. 7 is a side elevational view of the feeder of FIG. 6;

FIG. 8 is a bottom perspective view of the feeder of FIGS. 6; and

FIG. 9 is a bottom view of the feeder of FIG. 6.

### DESCRIPTION OF THE PREFERRED EMBODIMENT

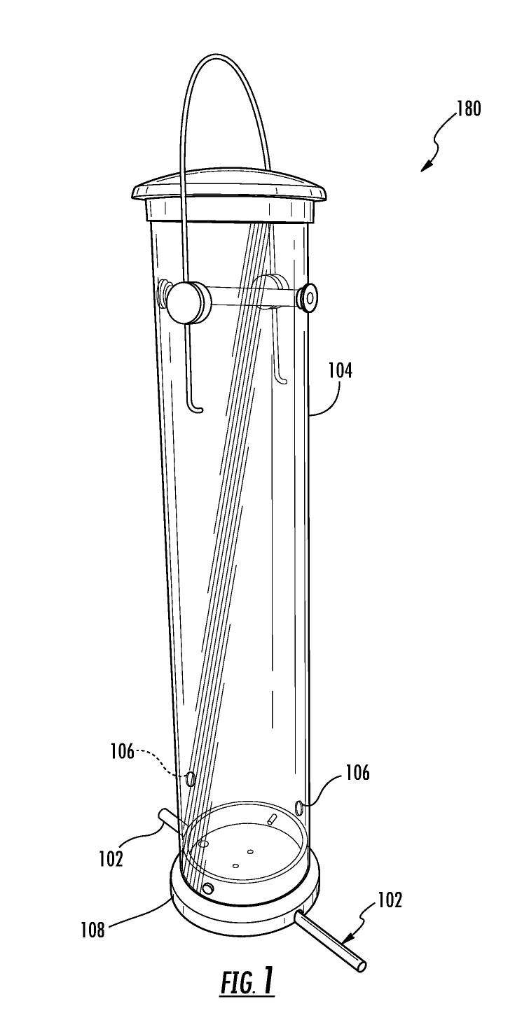

Referring now to FIG. 1, a feeder employing the perch assembly of the present invention is generally shown at 100. It should first be noted that the present invention is directed to a new and novel collapsible perch assembly 102 that may be used in any type of bird feeder. For illustration purposes only, the collapsible perch assembly 102 is shown herein in connection with use on a tubular bird feeder body 104 where the new and novel perch assembly 102 is configured to be the lowermost perch on the feeder 100 so desired birds can have access and reach the feeder ports 106 in the bird feeder body 104. However, due to the construction of the collapsible perch 102 of the present invention, this perch 102 can only be used for the lowermost perch so it is shown as such in the figures. Also, since the present perch 102 must be the lowermost perch, it has particular use in hopper-type feeder where all of the perches are in one row on the base, i.e. they are all “lowermost” perches. Therefore, use of the perch of the present invention for a tubular feeder as shown is just one example of the environment where the present perch can be used.

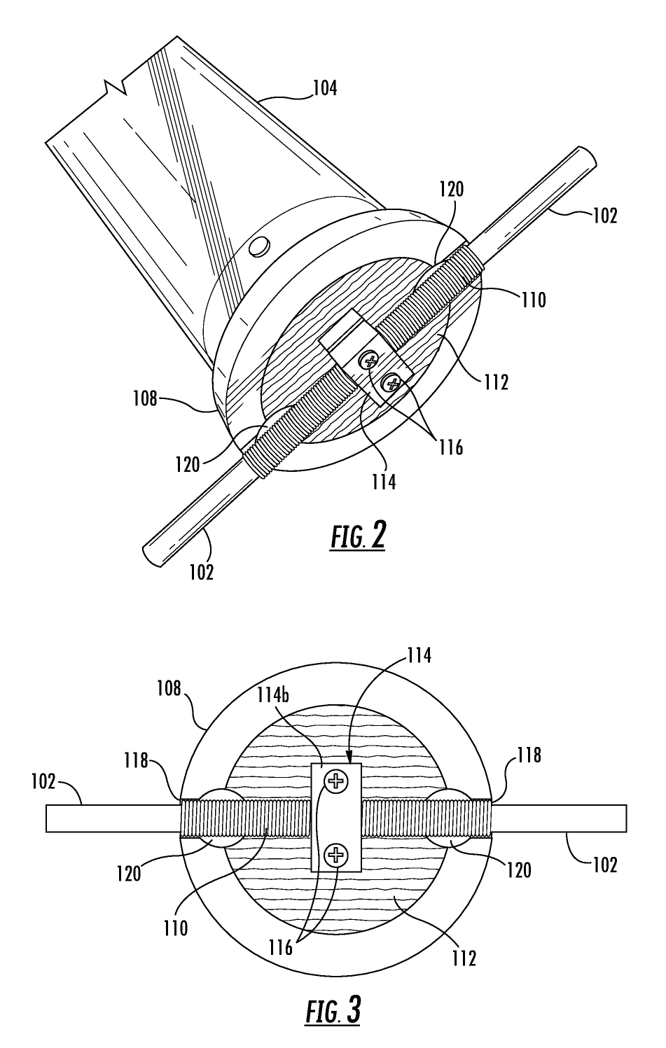

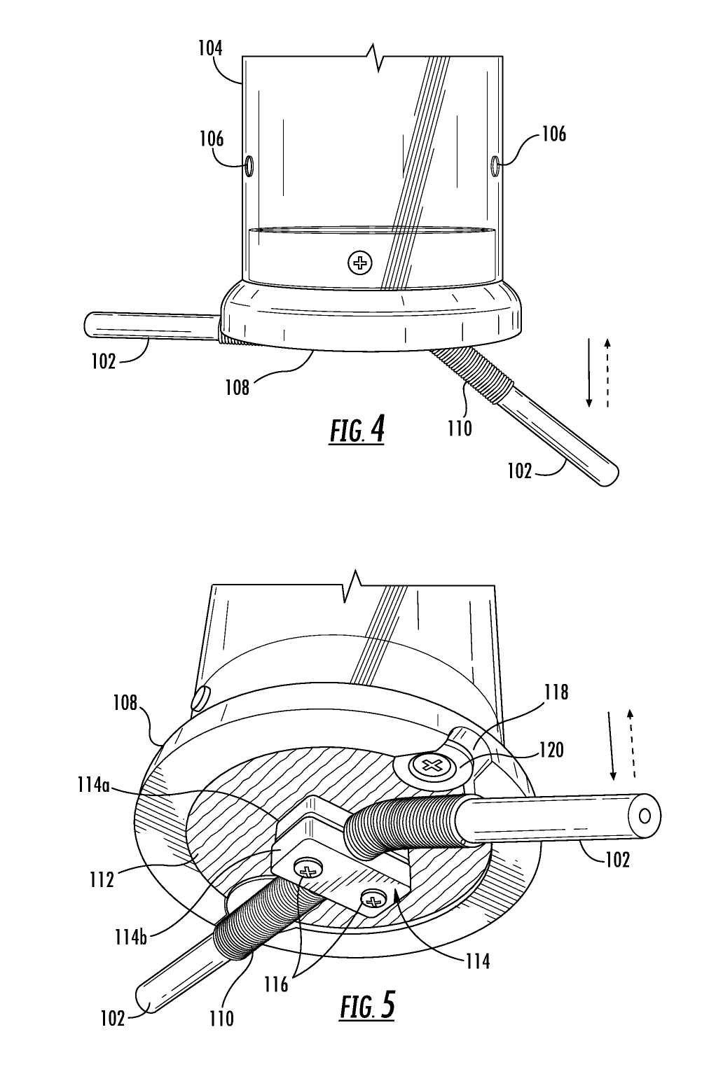

Referring now to FIGS. 2 and 3, the perch 102 of the present invention is shown in a resting condition that is suitable for supporting birds that are desirable and under a predetermined weight. The base 108 of the feeder 100 includes a coil spring 110 that is secured to the bottom 112 of the base 108 via a clamp member 114. As can be seen in FIG. 5, this clamp 114 includes a first portion 114a attached directly to the base 108 and a C-shaped portion 114b that is secured thereto, such as by threaded fasteners 116 with the coil spring 110 captured therein. For example, the middle of the coil spring 110 can be captured by the clamp 114 so the length of coil spring 110 on either side is about the same. Structures and mechanisms other than clamps 114 can be used to retain the coil springs in place. Preferably cylindrical perch members 102 are respectively inserted into the opposing free ends of the coil spring 110 to create two spring biased perch members, as seen by the broken lines in FIG. 2. The perches 102 may be retained therein by friction or with the assistance of an adhesive, or the like.

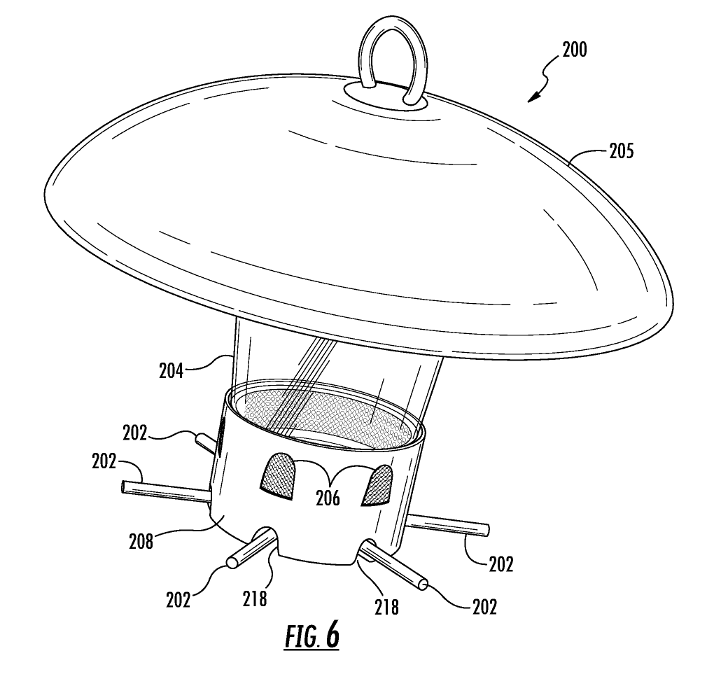

The coil springs 110 provide a flexible and spring-biased connector for the perch members 102, which spring-biases the perches 102 up to a home position, namely a perch seat 118, as seen in FIGS. 3 and 5. The home position seat 118 may be arc-shaped to capture the perch member 102 therein. Although the shape of the perch home position seat 118 may be any shape that captures the perch member 102, the perch home position seat 118 preferably has a shape complimentary to the shape of the perch member 102. The direction of spring-biasing can be seen by the solid arrow in FIGS. 4 and 5. Magnets 120 are secured to the bottom 112 of the base 108 directly above the resting position of the perch 102 and near the perch seats 118. The magnets 120 help orient and center the perches 102 so they can more easily find their “home” position.

The tension of the spring 110 provides the primary spring-biasing of the perch 102, which is tuned to a desire weight of an unwanted animal. Also, the strength of the magnet 120 can be employed to assist in retaining the perch 102 in the home feeding position but is primarily for bringing the perch 102 back to its centered home position. For example, the coil spring 110 can be tuned to break away downwardly upon the weight of one or two pounds, depending on the size of the animal that is an unwanted threat to the feeder 100. The tension of the spring 110 and the magnetic strength of the magnet 120 can be easily modified as desired.

In use, with no birds on the perch 102, the perch 102 is in a resting condition, as in FIGS. 1-3. When a desired small bird would like to feed, they land on the perch 102 and, due to their low weight, which is below the tuned weight of the coil spring 110, the perch 102 on which they are standing remain still, as in FIGS. 1-3. This permits the bird to access the associated feed port 106, such as the feed port 106 in FIG. 1, and the feed therein (not shown in FIG. 1).

If a bird or a squirrel with a weight that exceeds the tuned weight of the coil spring 110, the perch 102 will collapse as can be seen in the rightmost perch 102 in FIGS. 4 and 5. The perch 102 collapses against the forces of the coil spring 110. Such collapsing will disrupt the stance of squirrel or large bird and cause them to reject the feeder 100 and seek feed elsewhere. Even if a bird or other animal is still connected to the perch 102 when it is collapses, the distance to the feed port 106, as in FIG. 4, will be great enough to discourage the larger animal from accessing the feed in the body 104 via the feed port 106.

Upon removal of the unwanted animal, that is too large, from the collapsed perch 102, the perch 102 will snap back upwards in the direction of the broken arrow in FIGS. 4 and 5 with the assistance of the coil spring 110 and orient and center itself into its home position with the assistance of the magnet 120. With the perch 102 re-seated into its home position, it is ready to receive a bird for feeding.

The present invention is shown with a single clamp 114 to provide two opposing perches 102. It is should be understood that this is only one example of how the perches can be configured. For example, there may be one clamp 114 for each perch 102 where the clamp 114 secures one end of the coil spring 110 on only one end of the coil spring 110 receives a perch member 102. For example, a hopper style feeder 200 may employ such a configuration where more than two perches 202 are provided about the periphery of the feeder 200.

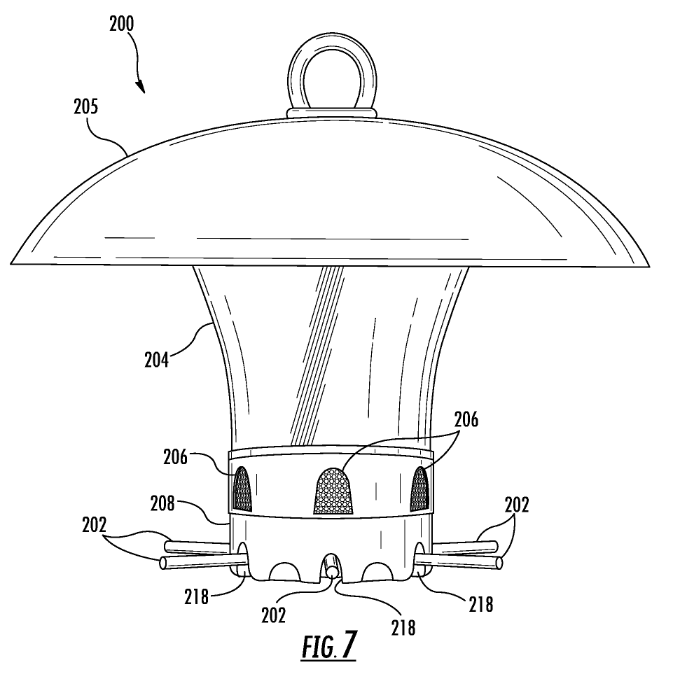

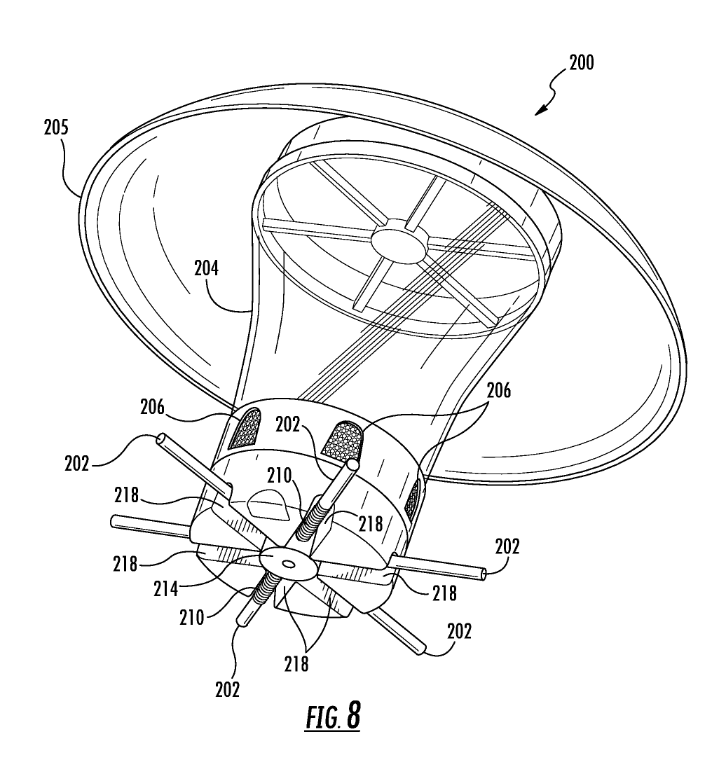

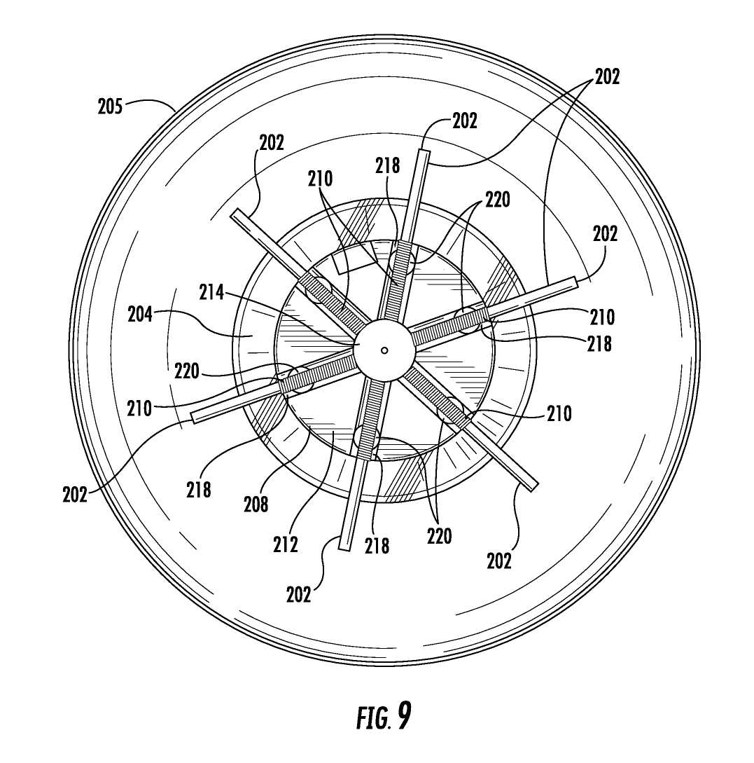

FIGS. 6-9 show the collapsible perch 202 of the present invention used in such a hopper style feeder 200. As indicated above, this type of feeder includes a single row of perches 202 that are collapsible. The operation and function of the collapsible perch 202 is the same as what is shown and discussed in detail above in FIGS. 1-5. This bird feeder configuration includes a main body 204 to house the feed therein with a protective dome 205 on the top thereof. A base 208 is provided on the bottom of the main body 204 to receive and contain the feed and deliver it through the feed openings 206 to a bird feeding thereon and sitting on a perch 202. The feed openings 206 are arranged radially about the periphery of the main body 204 to provide feed to a bird sitting one of the corresponding perches 202 in front thereof. The use of the collapsible perches 202 in a hopper style feeder 200, shown in FIGS. 6-9, is just one of many different configurations of a bird feeder in which the present invention can be used

The collapsible perches 202 are arranged about the periphery of the base 204 and are spring-biased upwardly into their respective seat notches 218 with coil springs 210 fastened to the bottom 212 of the base 208 with a clamp 214. Like the tubular feeder 100, the clamp 214 on the hopper style feeder 200 captures one end of each of the coil springs 210, leaving the other end of the coil springs 210 free to receive its respective perch 202. Located within each seat notch 218 is a magnet 220, which, as indicated above, aids the coil spring 210 in returning the perch 202 returning to the seat notch 218.

Optionally, it is possible that there is only one perch 102, 202 or more than two perches 102, 202 provided, depending on the desired configuration. The coil springs 110, 210 are preferably metallic to provide magnetic attraction to the magnets 120, 220. The perch members 102, 202 need not be attracted to magnets 120, 220 but that can be an option, if desired. Also, the reverse is possible where the coil spring 110, 210 is magnetic while the perch member 102, 202 secured on the bottom of the base 104, 204 is metal.

It would be appreciated by those skilled in the art that various changes and modifications can be made to the illustrated embodiments without departing from the spirit of the present invention. All such modifications and changes are intended to be within the scope of the present invention.

What is claimed is:

1. A bird feeder, comprising:
a feed body having a feed port therethrough;
a base attached to the bottom of the feed body; the bottom of the base defining a perch home position seat;
a magnet attached to the bottom of the base proximal to the home position seat;
a coil spring attached to the bottom of the base; the coil spring defining an open end;
a perch member partially disposed in the coil spring via the open end;
whereby the coil spring spring-biases the perch attached thereto into the perch home position seat and whereby the magnet orients and centers the perch in its home position seat.

2. The bird feeder of claim 1, wherein the bird feeder is a hopper style bird feeder with a single row of a plurality of perches arranged about a periphery of the feeder.

3. The bird feeder of claim 1, wherein the coil spring is attached to the bottom of the base with a clamp.

4. The bird feeder of claim 3, wherein the clamp comprises a first portion attached to the bottom of the base and a second portion attached to the first portion.

5. The bird feeder of claim 4, wherein the second portion of the clamp comprises a C-shaped surface configured and arranged to capture the coil spring against the first portion of the clamp.

6. The bird feeder of claim 3, wherein the clamp is configured and arranged to capture a middle portion of the coil spring.

7. The bird feeder of claim 3, wherein the clamp is configured and arranged to capture an end of the coil spring.

8. The bird feeder of claim 3, where the clamp is configured and arranged to capture a plurality of coil springs.

9. The bird feeder of claim 8, wherein the plurality of coil springs are spaced apart and extend radially away from the clamp.

10. The bird feeder of claim 1, wherein the perch home position seat comprises an arc shaped surface.

11. The bird feeder of claim 1, wherein the perch member is cylindrical.

12. The bird feeder of claim 1, wherein the coil spring is cylindrical.

13. The bird feeder of claim 1, further comprising
a plurality of perch members extending radially away from the base;
the base further defining a plurality of home position seats; each home position seat corresponding to one of said plurality of perch members; and
a plurality of magnets attached to the bottom of the base proximal to the plurality of home position seats.

14. The bird feeder of claim 1, wherein the magnet is located within its respective home position seat.

15. A bird feeder, comprising:
a feed body having a feed port therethrough;
a base attached to the bottom of the feed body; the bottom of the base defining a plurality of perch home position seats;
a plurality of magnets attached to the bottom of the base, one of each of the plurality of magnets proximal to one of each of the plurality of the home position seats;
a plurality of coil springs attached to the bottom of the base; each coil spring having an open end;
a plurality of perch members, each of said plurality of perch members partially disposed in one of each of said plurality of coil springs via the open end;
whereby each coil spring independently spring-biases the perch member attached thereto into the respective perch home position seat and whereby the respective magnet orients and centers the perch in its respective home position seat.

16. The bird feeder of claim 15, wherein the bird feeder is a hopper style bird feeder with a single row of a plurality of perches arranged about a periphery of the feeder.

17. The bird feeder of claim 15, wherein the coil spring is attached to the bottom of the base with a clamp.

18. The bird feeder of claim 15, wherein the perch members are spaced apart radially about the base.

19. The bird feeder of claim 15, wherein each magnet is located within its respective home position seat.
